(19) United States
(12) Patent Application Publication
(10) Pub. No.: US 2026/0229123 A1
(43) Pub. Date: Aug. 6, 2026

(54) SYSTEM FOR CONTROLLING A PRIVATE PARKING LOT AND METHOD OF IMPLEMENTING THE SAME

(71) Applicant: TENDOTECH THINKING OUT OF THE BOX LTD, Azor (IL)

(72) Inventors: Emil FUZAILOV, Azor (IL); Evgeni-Jashua FUZAILOV, Azor (IL); Yitzchak LEVY, Azor (IL)

(21) Appl. No.: 19/047,007

(22) Filed: Feb. 6, 2025

(51) Int. Cl. G08G 1/14; G06V 20/54; G06V 20/62

(52) U.S. Cl. CPC G08G 1/149; G06V 20/54; G06V 20/625; G08G 1/142

(57) ABSTRACT

The present invention discloses methods and systems, modules and cellular application for controlling a parking lot of limited access. It comprises a detector configured for proving an identifying signal of either or both vehicle and its driver/passenger to be parked in said parking lot; an identifying signal processing module configured for identifying said identifying signal of either or both vehicle and its driver; a gate arrangement configured for reversibly blocking and unblocking an access of unauthorized vehicles to said parking lot; optionally, a motion detector intercommunicated with said detector; a schedule unit configured for time managing parking lot occupancy; a database of either or both time-resolved “allowed and “NOT-allowed” identifications belonging to vehicles authorized at said parking lot; and a controller configured for receiving either or both vehicle and its driver/passenger, interrogating said database and configured for, if said identification is “allowed” at a relevant time-period, commanding said gate arrangement to unblock said access; and if said identification is “NOT-allowed” at said relevant time-period, commanding said gate arrangement to block said access.

### FIELD OF THE INVENTION

The present invention relates to controlling parking lots and, more particularly, to devices and methods for managing parking lots of restricted access.

### BACKGOUND OF THE INVENTION

Various aspects of parking management, including emerging technologies and new schemes to efficient usage of parking resources, are extensively studied, e.g., pricing strategy, real-time parking slot reservation and allocation. Private parking slots could be actually utilized to mitigate parking challenge under proper circumstance. In general, a typical feature of commuting in an urban residential area is the daily ‘go out early and come back at dusk’ pattern, i.e., private parking slot owners drive their cars out to work in the morning and will be back in the evening, which makes their private parking slots idle during their out time. These idle slots can be efficiently utilized to satisfy the parking demand of other drivers with flexible parking schedules for non-work activities (e.g., shopping, watch movies with optional times etc.). Here, the non-work activity is different from the work activities with tight time scheduling, and it allows adjustable schedule with time flexibility.

Because of the rapid increase of vehicle numbers and land values, there is an increasing shortage in the supply of parking facilities in many cities. In many parking lots, residential drivers bought private parking spaces with high prices to ensure that they have spaces to park at any time. Recently, some parking lot operation companies plan to temporally repurchase a few private parking spaces back during certain time periods in a day and sell these places to public users to fully utilize the limited parking resources. How to choose the repurchase amounts and stopping time so as to maximize the profit then becomes an important problem. To solve this problem, a Gaussian mixture model is first proposed in this article to describe the time-varying arriving/departing behaviors of drivers and meanwhile the stochastic constraints of the profit maximization problem. Then, the expected optimal repurchase amounts and stopping time are estimated via simulation optimization. This new approach not only provides a useful statistical tool for parking spaces modeling but also overcomes several key limitations of current queuing-based methodologies. Particularly, it emphasizes how to model drivers'behaviors on a small time-scale and explains the resulting benefits.

Thus, there is a long-felt and unmet need for devices and method of implementation of sharing private parking spaces which provide an access to the aforesaid parking spaces only to authorized vehicles.

### SUMMARY OF THE INVENTION

It is hence one object of the invention to disclose a system for managing a private parking lot; said parking lot comprising a plurality of parking places. The afooresaid system comprises: (a) a detector configured for sensing an identifying signal of a vehicle and being authorized to be parked in said parking lot; (b) a database comprising time-resolved allowed identifications corresponding to said identifying signals and belonging to vehicles authorized for lessees at said parking lot; (c) a gate arrangement configured for unblocking access if said identification belongs to a vehicle authorized for lessees at said parking lot and blocking said access otherwise; (d) a control unit configured for: (i) receiving an identified signal from said signal processing module; (ii) interrogating said database if said identified signal corresponds to one of said identifications stored in said database; (iii) commanding said gate arrangement to provide said access if said identification is allowed at a current time-period.

The controller comprising a signal processing module configured for identifying said identifying signal of said vehicle; said controller comprising a scheduling module configured for time management of occupancy of said parking places; said scheduling module being configured for receiving instructions from an owner of said private parking lot relating to reserving said parking places for a time period of interest.

The main feature of the invention to be disclosed is that said allowed identified vehicle comprises an onboard camera being in wireless communication with said control unit. Each of said parking places comprises a unique identification sign; said onboard camera is configured for capturing an image of said unique identification sign and wirelessly transmitting a captured image of said unique identification sign to said processing module which is configured for recognizing said unique identification sign; said control unit is configured for marking said parking place having said unique identification sign in said database as a parking place occupied by said allowed identified vehicle.

Another object of the invention is to disclose the identifying signal which is a license plate.

A further object of the invention is to disclose the detector which is a gate camera configured for capturing said license plate of said vehicle.

A further object of the invention is to disclose the database of identifications comprises license numbers of said vehicles.

A further object of the invention is to disclose a method of leasing a parking lot belonging to a private owner. The parking lot comprises a plurality of parking places. The aforesaid method comprises steps of: (a) providing a system for managing a private parking lot; said parking lot comprising a plurality of parking places; said system comprising: (i) a detector configured for sensing an identifying signal of a vehicle and being authorized to be parked in said parking lot; (ii) a database comprising time-resolved allowed identifications corresponding to said identifying signals and belonging to vehicles authorized for lessees at said parking lot; (iii) a gate arrangement configured for unblocking access if said identification belongs to a vehicle authorized for lessees at said parking lot and blocking said access otherwise; (iv) a control unit configured for: (1) receiving an identified signal from said signal processing module; (2) interrogating said database if said identified signal corresponds to one of said identifications stored in said database; (3) commanding said gate arrangement to provide said access if said identification is allowed at a current time-period; said controller comprising a signal processing module configured for identifying said identifying signal of said vehicle; said controller comprising a scheduling module configured for time management of occupancy of said parking places; said scheduling module being configured for receiving instructions from an owner of said private parking lot relating to reserving said parking places for a time period of interest; the allowed identified vehicle comprises an onboard camera being in wireless communication with said control unit; each of said parking places comprises a unique identification sign; said onboard camera is configured for capturing an image of said unique identification sign and wirelessly transmitting a captured image of said unique identification sign to said processing module which is configured for recognizing said unique identification sign; said control unit is configured for marking said parking place having said unique identification sign in said database as a parking place occupied by said allowed identified vehicle; (b) sensing said identifying signal by said detector; (c) identifying said identifying signal by said signal processing module; (d) validating an identified signal against said database; (e) commanding said gate arrangement to provide access for said identified vehicle to said parking lot; (f) placing said identified vehicle in said parking place; (g) capturing said image of said unique identification sign; (h) transmitting said captured image to said control unit; (i) recognizing said unique identification sign; and (j) marking said parking place having said unique identification sign in said database as a parking place occupied by said allowed identified vehicle.

A further object of the invention is to disclose the step of sensing said identifying signal comprising sensing a license plate.

A further object of the invention is to disclose the step of sensing said license plate performed by a gate camera.

A further object of the invention is to disclose the step of validating an identified signal against said database comprising indicating said license numbers of said vehicles within said database.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic diagram of a system for managing a parking lot; and

FIG. 2 is a flowchart of a method of managing a parking lot.

### DETAILED DESCRIPTION OF THE INVENTION

The following description is provided, so as to enable any person skilled in the art to make use of the invention and set forth the best modes contemplated by the inventor of carrying out this invention. Various modifications, however, are adapted to remain apparent to those skilled in the art, since the generic principles of the present invention have been defined specifically to provide systems for controlling a parking lot of limited access and leasing a parking lot belonging to a private owner and methods of implementing the same.

The term “parking lot of limited access” refers hereinafter to a parking lot to be used by a legally limited category of drivers such as disabled people, people affiliated with private or public institutions or like. According to the present invention, the system is configured for checking if the vehicle which is going to park up in the aforesaid parking lot. The system provides an access of the authorized vehicles to the parking lot and blocks the access of the unauthorized vehicles.

The term “vehicle” refers hereinafter to any machine that transports people or cargo, including electric vehicles, means for mass-mobility, macro-mobility and micro-mobility.

The term “license plate” refers hereinafter in a narrow manner to vehicle registration plate, number plate that provided useful for registration identifier in electronic manner, magnetic manner, passive manner, active manner, conventional manner, e.g., a numeric or alphanumeric identification that uniquely identifies the vehicle or vehicle's owner, driver or passenger. In wider scope, the term refers to any mean and method for identifying vehicle or vehicle's owner, driver or passenger.

The term “parking lot owner” refers hereinafter to a private person or entity owning and managing the parking lot. The parking lot owner can let out for lease the parking lot for time periods when the parking lot is not occupied by other vehicles, for example, by the vehicles belonging to the parking lot owner. If the parking lot to be leased is dedicated for a special category, the restrictive measures described above are applicable.

The term “lessee” refers hereinafter to a private person or entity owning a vehicle to be parked up in the parking lot belonging to the parking lot owner.

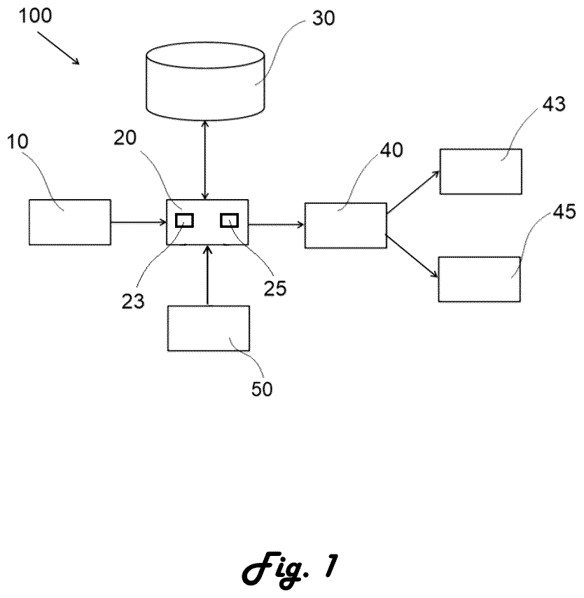

Reference is now made to FIG. 1 presenting a schematic diagram of system 100 for managing a parking lot of limited access. As mentioned above, system 100 is configured for providing an access of authorized vehicles to the parking lot and blocking the access of unauthorized vehicle. According to the present invention, the system 100 is configured for assisting the parking lot owner to timely manage the parking lot and letting out for lease the parking places for time periods when the parking lot is not occupied by his or her vehicle. System 100 comprises detector configured for sensing an identifying signal of a vehicle and being authorized to be parked in the parking lot. A license plate, a graphic insignia, and RFID chip mounted on the authorized vehicles are in the scope of the present invention. According to one exemplary embodiment, camera 10 is configured for capturing an image of a license plate of a vehicle to be parked. Camera 10 is positioned at entrance of the parking lot. Mounting camera 10 flush with the road surface and on a pillar is in the scope of the present invention. Camera 10 captures an image of a license plate of a vehicle to be parked up when the aforesaid vehicle comes to the parking lot entrance. Numeral 20 refers to a control unit comprising processing unit 23 for license number recognition within the captured license plate image. The processing modules and methods thereof are provided useful by means disclosed and reviewed by Kamaruzaman et al., “PARKEY: ticket-less parking system using license plate recognition approach.” Journal of Physics: Conference Series.1860 (1). IOP Publishing, 2021; and Thai-Nghe et al., “An approach for building an intelligent parking support system.” Proceedings of the Fifth Symposium on Information and Communication Technology. 2014. Control unit 20 is configured for interrogating database 30 storing the license numbers belonging to the vehicles authorized to be parked in the parking lot. The parking lot entrance is equipped with gate arrangement 40 configured for providing an access of the authorized vehicles to the parking lot and blocking an access of unauthorized vehicles. Gate arrangement 40 can include display means 43 informing a driver if the vehicle is authorized to be parked in the parking lot and means 45 for blocking access to the parking lot in the case that the coming vehicle is not authorized to be parked there.

It is well in the scope of the invention wherein the system is powered by either or both thermal Peltier and Paltrier-like modules, photovoltaic or solar cells, and a combination of the same. Alternatively, energy-wise, the system is totally independent from of any outside source. Alternatively, at least some of the energy is provided from batteries, the electrical grid, electric to mechanic module harvesting vehicle or wind movement, and any combination thereof.

Control unit 20 further comprises schedule unit 25 configured for time managing parking lot occupancy. According to the first embodiment of the present invention, schedule unit provides the drivers of the authorized vehicles with an option of advance booking the parking lot. Referring to the second embodiment of the present invention, the owner of the parking lot defines the time slots when the parking lot is not occupied and can be leased.

According to the present invention, the allowed identified vehicle (not shown) is provided with an onboard camera 50 which is in wireless communication with control unit 20. The parking lot is divided into a plurality of parking places. Each parking place is provided with a unique identification sign such as a QR-code, a barcode, an alphabetical or graphical symbol or like. Onboard camera 50 is configured for capturing an image of the unique identification sign and wirelessly transmitting a captured image of said unique identification sign to processing unit 23 which is configured for recognizing said unique identification sign and marking said parking place having said unique identification sign in said database as a parking place occupied by said allowed identified vehicle.

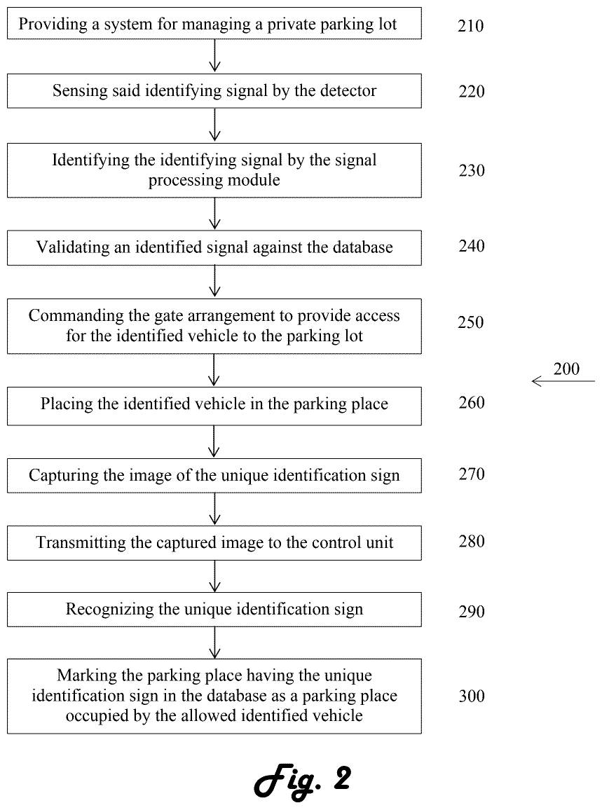

Reference is now made to FIG. 2 presenting method 200 of managing a parking lot of limited access (first embodiment). In the beginning a system for controlling a parking lot of limited access described above is provided (step 210). The identifying signal belonging to the authorized vehicle is sensed by the detector. In accordance with the exemplary embodiment, when the vehicle license plate is positioned in a field of view of the camera, the aforesaid camera captures an image of the license plate of the vehicle to be parked (step 220). The obtained image is recognized in the image processing unit (step 230) such that a license number is derived. Then, the control unit validates the derived license number against the database (step 240). Access to the parking lot is allowed if the recognized license number belongs to the authorized vehicle (step 250). In the case that the recognized license number does not belong to the authorized vehicle the access is blocked.

The vehicle entered into the parking lot is driven by its driver to an unoccupied parking place (step 260). Each parking place is provided with a unique identification sign. The onboard camera captures an image of the unique identification sign of the occupied parking place (step 270). The captured image is transmitted to the processing module (step 270). The image of the unique identification sign is recognized in the processing module (290). Then, the occupied parking place having the recognized unique identification sign is marked in the database as a parking place occupied by the parked vehicle.

It is an embodiment of the invention to disclose a monitoring arrangement, e.g., restricted or reserved parking zone, which includes several intercommunicated modules: One of which is an identification reader. The reader is selected from optical reader, tag scanner, magnetic reader, biometric scanner, digital license plates readers (DLPs), electronic license plates scanners etc.

It is an embodiment of the invention wherein the optic reader is either or both fixed CCD, movable PTZ camera, video surveillance camera, thermal camera, automatic license plate readers etc. Those one or more stiles or video cameras are positioned on a predefined location, such as in elevated position on an erected post, on the parking surface at ground level etc. The optic reader is configured for capturing an identifying image, e.g., a license plate of a vehicle to be parked driver's face, barcode, vehicle plate barcode system (VPBS), Hence, it is in the scope of the invention when a motion detector is interconnected to the optic sensor. At time a vehicle approaching the parking zone, motion detector signals the optic sensor to read vehicle or driver identification. Such a motion detection is provided useful by means disclosed and reviewed by Burnos et al., “The effect of flexible pavement mechanics on the accuracy of axle load sensors in vehicle weigh-in-motion systems.” Sensors 17.9 (2017): 2053; and Yang et al., “Vehicle detection in intelligent transportation systems and its applications under varying environments: A review.” Image and Vision Computing 69 (2018): 143-154.

It is also in the scope of the invention wherein a module of an image processing unit is configured for recognizing an identification insignia, e.g., car's license number within the identifying data or signal, e.g., an image of the license plate. Another module is a gate arrangement configured for reversibly blocking an access of those who are unauthorized or unlicensed, such as vehicles that are not permitted to park at a given time in aforesaid parking zone.

It is well in the scope of the invention wherein the cellular application is intercommunicated with users'smart phone and scheduling application thereof. It is well in the scope of the invention wherein the system lawfully learns users'daily schedule and automatically or semi-automatically implement users'time-resolve location and future plans regarding the parking lot within said cellular application.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for managing a private parking lot; said parking lot comprising a plurality of parking places; said system comprising:
i. a detector configured for sensing an identifying signal of a vehicle and being authorized to be parked in said parking lot;
ii. a database comprising time-resolved allowed identifications corresponding to said identifying signals and belonging to vehicles authorized for lessees at said parking lot;
iii. a gate arrangement configured for unblocking access if said identification belongs to a vehicle authorized for lessees at said parking lot and blocking said access otherwise;
iv. a control unit configured for:
1. receiving an identified signal from said signal processing module;
2. interrogating said database if said identified signal corresponds to one of said identifications stored in said database;
3. commanding said gate arrangement to provide said access if said identification is allowed at a current time-period;
said controller comprising a signal processing module configured for identifying said identifying signal of said vehicle; said controller comprising a scheduling module configured for time management of occupancy of said parking places; said scheduling module being configured for receiving instructions from an owner of said private parking lot relating to reserving said parking places for a time period of interest;
wherein said allowed identified vehicle comprises an onboard camera being in wireless communication with said control unit; each of said parking places comprises a unique identification sign; said onboard camera is configured for capturing an image of said unique identification sign and wirelessly transmitting a captured image of said unique identification sign to said control unit which is configured for recognizing said unique identification sign and marking said parking place having said unique identification sign in said database as a parking place occupied by said allowed identified vehicle.

2. The system according to claim 1, wherein said identifying signal is a license plate.

3. The system according to claim 2, wherein said detector is a gate camera configured for capturing said license plate of said vehicle.

4. The system according to claim 1, wherein said database of identifications comprises license numbers of said vehicles

5. The system according to claim 1, wherein said gate arrangement comprises a display configured for informing drivers of vehicles about availability of said parking lot to said vehicles.

6. A method of leasing a private parking lot; said parking lot comprising a plurality of parking places; said method comprising steps of:
a. providing a system for managing a private parking lot; said parking lot comprising a plurality of parking places; said system comprising:
i. a detector configured for sensing an identifying signal of a vehicle and being authorized to be parked in said parking lot;
ii. a database comprising time-resolved allowed identifications corresponding to said identifying signals and belonging to vehicles authorized for lessees at said parking lot;
iii. a gate arrangement configured for unblocking access if said identification belongs to a vehicle authorized for lessees at said parking lot and blocking said access otherwise;
iv. a control unit configured for:
1. receiving an identified signal from said signal processing module;
2. interrogating said database if said identified signal corresponds to one of said identifications stored in said database;
3. commanding said gate arrangement to provide said access if said identification is allowed at a current time-period;
said controller comprising a signal processing module configured for identifying said identifying signal of said vehicle; said controller comprising a scheduling module configured for time management of occupancy of said parking places; said scheduling module being configured for receiving instructions from an owner of said private parking lot relating to reserving said parking places for a time period of interest; wherein said allowed identified vehicle comprises an onboard camera being in wireless communication with said control unit; each of said parking places comprises a unique identification sign; said onboard camera is configured for capturing an image of said unique identification sign and wirelessly transmitting a captured image of said unique identification sign to said control unit which is configured for recognizing said unique identification sign and marking said parking place having said unique identification sign in said database as a parking place occupied by said allowed identified vehicle;
b. sensing said identifying signal by said detector;
c. identifying said identifying signal by said signal processing module
d. validating an identified signal against said database;
e. commanding said gate arrangement to provide access for said identified vehicle to said parking lot;
f. placing said identified vehicle in said parking place;
g. capturing said image of said unique identification sign;
h. transmitting said captured image to said control unit;
i. recognizing said unique identification sign; and
j. marking said parking place having said unique identification sign in said database as a parking place occupied by said allowed identified vehicle.

7. The method according to claim 6, wherein said step of sensing said identifying signal comprises sensing a license plate.

8. The system according to claim 7, wherein said step of sensing said license plate is performed by a gate camera.

9. The system according to claim 6, wherein said step of validating an identified signal against said database comprises indicating said license numbers of said vehicles within said database.
